(19) United States
(12) Patent Application Publication
(10) Pub. No.: US 2005/0226532 A1
(43) Pub. Date: Oct. 13, 2005

(54) System and method for determining the size of an object

(76) Inventors: Robert Lee Thompson, Rogers, AR (US); David Bolen, Fayetteville, AR (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/816,229

(22) Filed: Apr. 1, 2004

(51) Int. Cl. G06K 9/36

(52) U.S. Cl. 382/286

(57) ABSTRACT

In one aspect of the invention, a system and method are provided for associating multi-media data with an electronic document. A first document editing software application opens a second multi-media capture application. The first application provides the second application with file names and a file system location at which to store created data files. A user uses the multi-media capture application to capture or create multi-media data. The second application then creates files including the multi-media data using the file names provided by the first application. The second application stores the files at the file system location provided by the first application. Because the first application provided the file names and file system location of the multi-media data to the second application, the first application may easily determine where the data is stored. The first application may then retrieve the data from this location to display to the user.

### FIELD OF THE INVENTION

The present invention relates generally to the manipulation of electronic documents and, more particularly, to systems and methods for associating multi-media data with an electronic document.

### DESCRIPTION OF RELATED ART

When creating or editing an electronic document, users sometimes find it desirable to include multi-media data in the electronic document. Such multi-media data may include, for example, still images, movies, audio data, or text. Some document editing software applications allow the user to add or attach multi-media data to electronic documents. These software applications typically require the user to input the file system location at which the multi-media data is stored, and the application can then retrieve the multi-media data from that location and include it in the electronic document. However, for such software applications to be able to access the multi-media data, the multi-media data must have been previously created and written to disk. Further, the user must know the exact file system location of the multi-media data that he or she desires to include in the electronic document.

### SUMMARY OF THE INVENTION

One illustrative embodiment is directed to a method comprising acts of: a) providing an electronic document that includes a button; b) in response to selection of the button, retrieving at least one picture that includes content previously associated with the electronic document; and c) displaying the at least one picture. Another illustrative embodiment is directed to at least one computer readable medium encoded with instructions that, when executed on a computer system, perform the above described method.

A further illustrative embodiment is directed to a computer system comprising: a display; and at least one controller, coupled to the display, that: provides an electronic document that includes a button; in response to selection of the button, retrieves at least one picture that includes content previously associated with the electronic document; and displays the at least one picture on the display.

Another illustrative embodiment is directed to a method comprising acts of: a) providing a first electronic document that includes a button at a first location in the document; b) in response to selection of the button, calling an image capture application to capture at least one image; and c) associating the at least one image captured by the image capture application with the first location in the first electronic document. A further illustrative embodiment is directed to at least one computer readable medium encoded with instructions that, when executed on a computer system, perform the above described method.

Another illustrative embodiment is directed to a computer system comprising: a display; and at least one controller, coupled to the display, that: a) provides a first electronic document that includes a button at a first location in the document; b) in response to selection of the button, calls an image capture application to capture at least one image; and c) associates the at least one image captured by the image capture application with the first location in the first electronic document.

A further illustrative embodiment is directed to a method of operating a computer, the computer having a display and executing a document management application that manages a first electronic document having a button and a data capture application that captures images from a data capture device. The method comprises acts of: a) in response to selection of the button, calling the data capture application so that the data capture application provides a live view from the data capture device on the display; and b) associating at least one image captured from the data capture device with the first electronic document. Another illustrative embodiment is directed to at least one computer readable medium encoded with instructions that, when executed on a computer system, perform the above described method.

A further illustrative embodiment is directed to a computer system comprising: a display; a data capture device; a data capture application that captures images from the data capture device; and at least one controller that: executes a document management application that manages a first electronic document having a button; in response to selection of the button, calls the data capture application so that the data capture application provides a live view from the data capture device on the display; and associates at least one image captured from the data capture device with the first electronic document.

Another illustrative embodiment is directed to a method of determining a size of an object. The method comprises acts of: a) capturing a digital image of a field of view that includes the object; b) determining the size of the field of view captured in the digital image; and c) determining the size of the object based on the size of the field of view capture in the digital image. A further illustrative embodiment is directed to at least one computer readable medium encoded with instructions that, when executed on a computer system, perform the above described method.

Another illustrative embodiment is directed to a computer system comprising: a display; at least one controller coupled to the display that: captures a digital image of a field of view that includes the object; determines the size of the field of view captured in the digital image; and determines the size of the object based on the size of the field of view capture in the digital image.

### BRIEF DESCRIPTION OF THE DRAWINGS

In the drawings, each identical or nearly identical component that is illustrated in various figures is represented by a like numeral. For purposes of clarity, not every component may be labeled in every drawing. In the drawings:

FIG. 1 is a block diagram of an illustrative computer system on which aspects of the present invention may be implemented;

FIG. 2 is a diagram of an electronic document with which multi-media data may be associated in accordance with one embodiment of the invention;

FIG. 3 is a flow diagram depicting a process used to associate multi-media data with an electronic document, in accordance with one embodiment of the invention;

FIG. 4 is a block diagram of an exemplary system in which a web browser and web server may be used to associate multi-media data with an electronic document, in accordance with one embodiment of the invention;

FIG. 5 is a flow diagram depicting a process used to associate multi-media data with an electronic document using a web browser and web server in accordance with one embodiment of the invention;

FIG. 6 is a block diagram of an exemplary system that may be used to transmit real time images over a computer network in accordance with one embodiment of the invention;

FIG. 7 is a perspective view of a measuring system according to one embodiment of the invention;

FIG. 8 is a cross-sectional view of a portion of the measuring system of FIG. 7; and

FIG. 9 is a flow diagram depicting a process used to determine the size of objects from images of the objects.

### DETAILED DESCRIPTION

Associating Multi-Media Data with Electronic Documents

One aspect of the invention is directed to a method and apparatus for associating multi-media data with an electronic document. As used herein, the term “electronic document” means any electronic data that may be presented in human-understandable form. Binary data that may be presented as human-understandable text and images in a word processing application is an example of an electronic document. Other examples of electronic documents include, but are not limited to, a world wide web (WWW) page that is displayed in a WWW browser, an electronic mail message (e-mail) displayed in an e-mail viewing application, one or more still images (e.g., digital photographs), and one or more moving images (e.g., a digital movie). It should be understood that an electronic document may include multi-media data, such as still images, movies, audio data, or text.

An example of a system on which aspects of the present invention can be employed is a portable apparatus for obtaining and storing aircraft maintenance information in electronic format. Such an apparatus is described in detail in U.S. Pat. No. 6,529,620, which is hereby incorporated by reference herein in its entirety. Maintenance workers may bring the apparatus to an aircraft when performing a maintenance check on the aircraft. The apparatus may execute a software application that allows the maintenance workers to edit an electronic maintenance checklist (e.g., check off tasks as they are completed) as the maintenance check is performed. The maintenance checklist may be, for example, an electronic document. A camera integrated into the apparatus allows maintenance personnel to closely inspect aircraft parts and capture images (i.e., still or moving images) of the aircraft. Embodiments of the present invention allow the maintenance workers, as they inspect the aircraft, to capture images of a particular aircraft part and associate those images with the portion of the electronic checklist that pertains to that particular part.

For example, a maintenance worker may wish to embed images directly in the electronic checklist document. Alternatively, the maintenance worker may desire to include in the checklist document a link (e.g., a hypertext link) to another electronic document which includes the desired multi-media data (e.g., the images). In one embodiment of the invention, the maintenance worker need not know where the data is stored (e.g., the file system location), as the electronic checklist document may provide a facility to automatically link the multi-media data to the document in a manner transparent to the user. Further, the multi-media data need not exist on the apparatus or in the memory of the camera prior to the editing of the checklist. Instead, in one embodiment the multi-media data (e.g., images) may be created as part of the process of filling out the checklist and associating the not yet existing data with the electronic checklist.

It should be appreciated that aircraft maintenance is only one example of an application in which associating images or other multi-media data that do not yet exist with an electronic document may be useful, and that the invention is not limited in this respect. For example, embodiments of the present invention can allow a real estate broker creating electronic listings for properties to edit such a listing and associate images of the property with a location in the electronic listing. Thus, it is not necessary for the broker to photograph the property separately, remember the file system location of the photographs, and associate the correct photographs with the correct listings at a later time. Instead, the broker may simply associate the images with the listings document as the images are taken.

As another example, an automobile salesperson may wish to create electronic descriptions of the automobiles presently on the lot (e.g., to post as advertisements on the Internet). Embodiments of the present invention allow the salesperson to open an electronic description of an automobile and capture images of that automobile, thereby directly associating those images with the electronic document.

Numerous other applications are possible, as the aspects of the present invention described herein are not limited to these or any particular applications.

The ability to associate multi-media data that does not yet exist with an electronic document, as performed in various embodiments of the present invention, is advantageous in that it obviates the need for a user to exit a first software application being used to edit the electronic document for the purpose of opening a second software application for capturing the multi-media data, as was necessary using conventional techniques. Further, embodiments of the present invention render it unnecessary for the user to determine a file system location at which the second software application stores the captured multi-media data and to return that file system location to the first software application so that the first software application may associate the multi-media data with the electronic document.

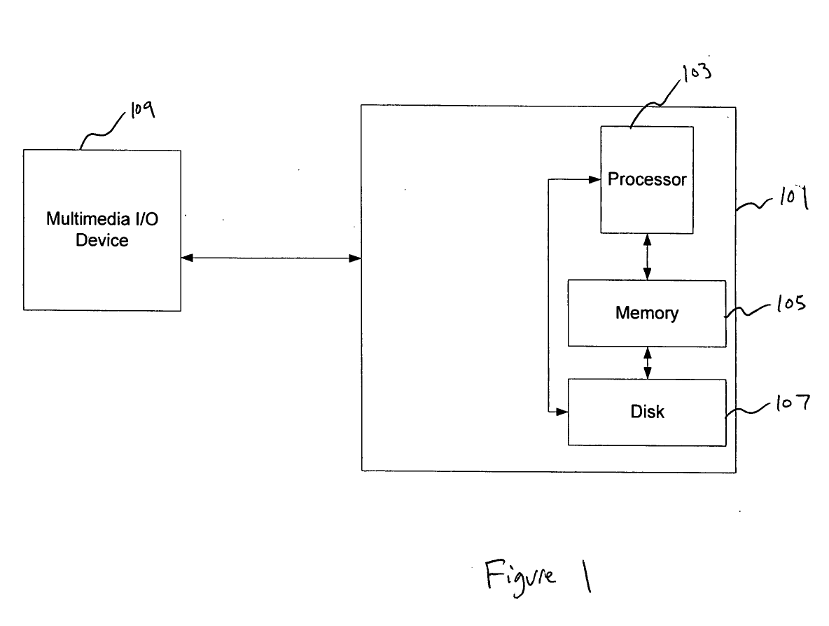

One embodiment of the present invention directed to associating multi-media data with an electronic document is described below. FIG. 1 is a simplified block diagram of a computer system 101 on which aspects of the present invention can be implemented. Computer system 101 includes a processor 103, a primary storage device 105, and a secondary storage device 107. Primary storage device 105 may be, for example, a volatile memory (e.g., RAM). Secondary storage device 107 may be, for example, a non-volatile memory (e.g., a magnetic or optical disk). Secondary storage device 107 may be a removable medium such as, for example, a removable optical disc or a removable magnetic disk or tape. Alternatively, secondary storage device 107 may be a fixed optical or magnetic medium.

Computer system 101 may be coupled to multi-media input/output (I/O) device 109. Multi-media I/O device 109 may be any device which is capable of capturing multi-media data. For example, multi-media I/O device 109 may be a digital camera capable of capturing still images and/or moving images. Multi-media I/O device 109 may also be, for example, a scanner capable of creating electronic images of physical documents, or a microphone and sound card capable of converting sound into digital signals. The above-devices are provided merely as examples of multi-media I/O devices that are suitable for use in embodiments of the present invention. It should be appreciated that multi-media I/O device 109 may be any type of device (or combination of devices) capable of creating or capturing multi-media data and making such multi-media data available in electronic form. An example of a combination of devices that form I/O device 109 can include a camera combined with a microphone, although numerous other combinations are possible.

Processor 103 may execute various software applications stored, for example, in primary storage device 105 and/or secondary storage device 107. Processor 103 may be capable of executing a first software application that allows a user to create or edit electronic documents and a second software application that allows a user to capture, create, or receive multi-media data from multi-media I/O device 109.

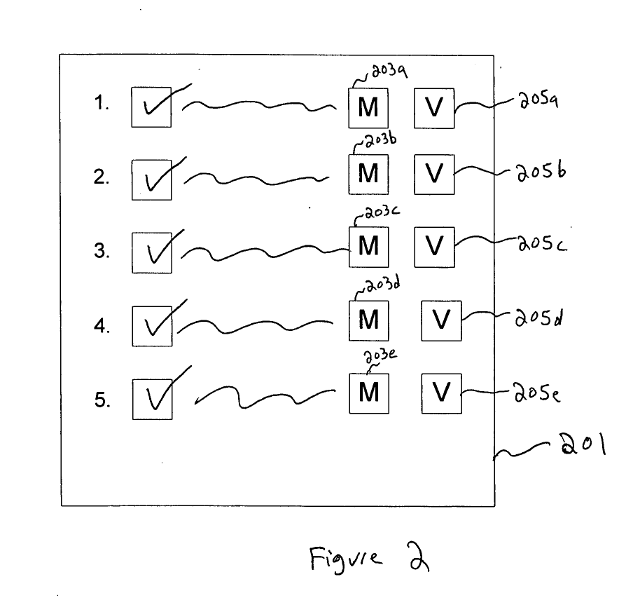

As discussed above, when creating or editing an electronic document using a first software application (e.g., a document editing application), a user may indicate to the first software application that he or she desires to include multi-media data of a specified form (e.g., still or moving images) at a particular place in the electronic document. FIG. 2 is a diagram of an example of an electronic document 201 that may be created or edited using a first software application in accordance with one embodiment of the invention. Document 201 is an electronic checklist (e.g., a maintenance checklist) that includes a number of items or tasks that may be checked off as they are performed.

In the example of FIG. 2, document 201 includes five items or tasks that may be checked off. It should be appreciated that this number is given only as an example and that document 201 may include any number of items or tasks to be checked off, as the invention is not limited in this respect. Additionally, document 201 need not be a maintenance checklist. Document 201 may be any of numerous other types of electronic documents, such as, for example, a real estate listing, an advertisement, a scientific paper, a newspaper, or a magazine article. Indeed, document 201 may be any type of electronic document with which it is desirable to associate multi-media data, as the invention is not limited to use with any particular type of document.

Document 201 includes a plurality of buttons 203a-203e, each labeled with an ‘M’ in FIG. 2. When a user desires to associate multi-media data with a particular item in document 201, the user may select the corresponding button 203. The user may select a button 203 in any suitable way (e.g., using an input device such as a keyboard, touch screen, or mouse). When a user selects a button 203, the first application “calls” the second application (i.e., the multi-media capture application) and provides the second application with information identifying where the multi-media data created or captured by the second application is to be stored. This information can be provided in any form (e.g., a file name and a file system location), as the invention is not limited in this respect. The user uses the second application and the multi-media I/O device 109 associated therewith to create or capture the desired multi-media data and store it at the location specified by the first application.

The first application “calling” the second application means that the first application causes the processor (e.g., processor 103) to execute instructions of the second application. If the second application is not yet loaded into the primary storage device, then the first application may cause the processor to load the second application (or at least portions thereof) into the primary storage device and begin executing instructions of the second application. If the second application is already loaded, the first application may cause the processor to begin executing instructions associated with the second application. In the case where the processor is a multi-tasking processor, the first application may remain open while the second application is in use.

When the first application “calls” the second application, it may provide the location information for the multi-media data in any suitable way, e.g., as a command line parameter or flag or through interprocess communication, such as, for example, dynamic data exchange (DDE), object linking and embedding (OLE), or UNIX pipes. After the multi-media data is captured, the first application may then retrieve it and display it to the user. The first application knows where the multi-media data is stored because the first application determined the storage location and provided it to the second application.

In one embodiment of the invention, the first application may use a naming convention to determine the location information that is provided to the second application for storing the multi-media data. When the first application retrieves the multi-media data to display to a user, the first application may determine the location at which the multi-media data is stored based on the naming convention. For example, when using a file name and file system location as the location information, the file system location that the first application provides to the second application may be a directory having the same name as the electronic document with which the data is associated. If such a directory does not yet exist, the first application may create such a directory. The name of the file provided to the second application may, for example, be derived from the place in the electronic document with which the multi-media data is associated. For example, if the multi-media data is associated with the second task in the checklist of document 201, the filename may be paragraph2.jpg.

If the user desires to associate more than one multi-media data file with a task in the checklist of document 201, the first application may instruct the second application to name the units of multi-media data in a manner to distinguish between the different data units. For example, if the user creates three multi-media data units (e.g., files) to associate with the second task of document 201 using the second application, the first application may instruct the second application to name the files paragraph2-1.jpg, paragraph2-2.jpg, and paragraph2-3.jpg. If the user initially creates a number of multi-media data files and then desires to add more multi-media data files at a later time (e.g., by again selecting the appropriate button 203), the first application may determine that a number of multi-media data files have already been associated with that particular place of the electronic document. Accordingly, the first application may instruct the second application to begin numbering the file names with the next number following the last multi-media data file name that was previously created for that document location. For example, if the user initially created three multi-media data files associated with the second task in the checklist of document 201 and later desires to add more multi-media data files, the first application may again open the second application, and instruct it to number the file names in series, beginning with paragraph2-4.jpg.

By using a naming convention to determine the file system location and file name of multi-media data files, the document editing software application (i.e., the first software application) need not use additional disk space to store the name and location of the multi-media data units captured by the second application. It should be appreciated that the naming convention described above is given only as an example. Many other naming conventions may be used, as long as the document editing software application is able to determine the location of the multi-media data units.

Further, it should be appreciated that the use of a naming convention is not limited to files and file systems. The naming convention may, for example, be adapted to specify specific block and block offset locations on a disk at which the multi-media data unit is physically stored. Thus, it is not necessary to store multi-media data units in a file system, as the invention is not limited to storing multi-media data units in files and/or using a naming convention that uses directory names and file names in a file system.

The first application may alternatively instruct the second application to store the multi-media data in a table, which in one embodiment is implemented in a database. For example, the first application may provide the document name and the document location (e.g., page number, line number, line position) with which the multi-media data is to be associated to the second application. The second application may then store the multi-media data in a database table that also includes the document location (e.g., page number, line number, line position) provided by the first application. Thus, the first application may retrieve the multi-media data by querying the database based on the particular document location and the database will return any multi-media data associated with that document location. Accordingly, the above-discussed naming convention may also be used in a database.

Alternatively, instead of storing the multi-media data directly in a table (e.g., in a database), the second application may store the multi-media data in another manner (e.g., as a file in a file system) and include the location information of the multi-media data in the table, along with the document location provided by the first application. Thus, the first application may query the table using a document location to determine the location (e.g., the file name and the file system location) of any multi-media data associated with that document location and the first application may then retrieve the multi-media data.

As discussed above, buttons 203a-e in document 201 of FIG. 2 may be associated with tasks in the checklist of the document and used to associate multi-media data with document 201. A “button” as used herein, may be any image, icon, or text that is selectable, and is not limited to any particular shape, color, or size. It should be understood that the placement of buttons 203 in document 201 is given only as an example, because buttons 203 may be distributed in any manner throughout document 201, as the invention is not limited in this respect.

In the above examples, the file names given to the multi-media data files used the file extension ‘jpg’, which is normally used for images files in the JPEG data format. However, it should be appreciated that these file names are given only as examples. The multi-media data files may include any type of multi-media data (e.g., still images, moving images, sound and text) and may be stored in any data format suitable for storing the particular type of multi-media data, as the invention is not limited in this respect.

Document 201 includes a plurality of buttons 205a-205e, each of which is labeled with a ‘V’ and indicates that there is multi-media data associated with the location in the electronic document at which the button 205a-e appears. Selecting a button 205a-e causes the first software application to retrieve the associated multi-media data and display it on an output device, such as a display screen (e.g., the display screen that displays document 201).

In an alternate embodiment, instead of using buttons 205a-e, the first software application may display the multi-media data directly in document 201, such that it is not necessary to select a button to view the multi-media data.

In one embodiment of the invention, buttons for displaying multi-media data (e.g., buttons 205) may appear in the electronic document even if no multi-media data is associated with the document location of the button. If a user selects a button at a document location with which no multi-media data is associated, the first software application may display a message to the user indicating that no such multi-media data exists. Thus, buttons may be distributed regularly throughout the document (e.g., every paragraph or every line), although not every button, when selected, displays multi-media data. However, the present invention is not limited in this respect, as in other embodiments a button 205 may be provided only where multi-media is present.

In one embodiment, document 201 may be opened in a read-only mode in which the first software application does not allow the user to modify the document. In the read-only mode, buttons for associating multi-media data with the document, such as buttons 203a-e in document 201, may be omitted from the document. Thus, the user does not have the ability to associate multi-media data with the document in read-only mode.

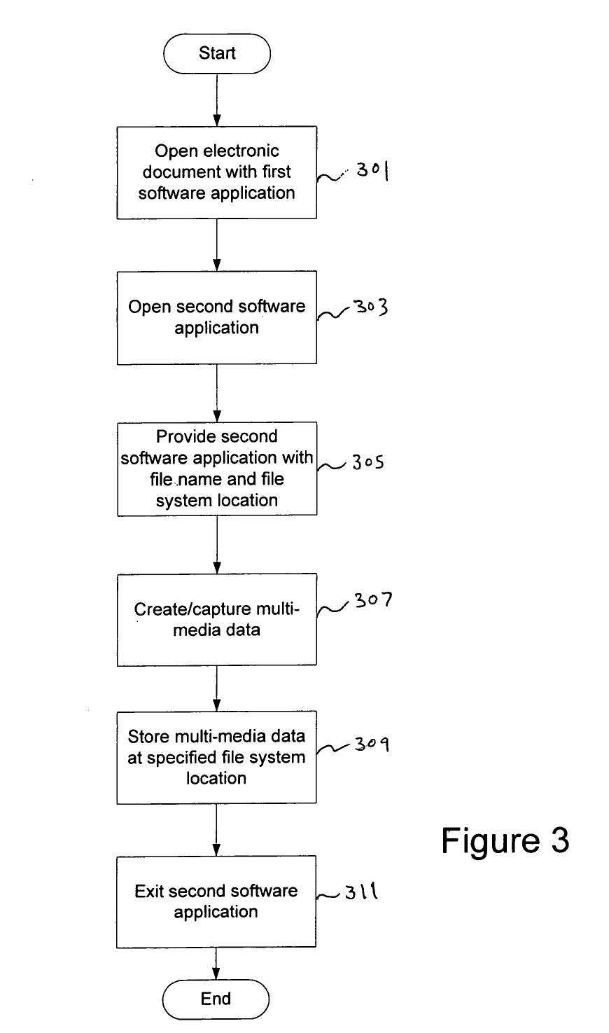

FIG. 3 is a flow chart that illustrates a process of associating multi-media data with an electronic document in accordance with one embodiment of the invention. The process begins at act 301, where a first software application opens the electronic document. The first software application may be, for example, a document editing or viewing application (such as a word processing application, an Internet web browser, or any other suitable application). When a user desires to associate multi-media data with a document opened by the first software application, the user may indicate this desire to the application in any suitable way (e.g., by selecting a button or an option from a menu), which causes the first software application to call a second software application in act 303 for capturing or creating multi-media data. The second software application may interface with a multi-media device such as a digital camera or scanner, or may capture or create multi-media data in any suitable way.

The process next continues to act 305, where the first software application provides the second software application with a file system location at which to store multi-media data files created by the second software application. The first software application also provides the second software application with file names for the multi-media data files. It should be appreciated that although the acts of opening the second software application and providing it with a file name and file system location are shown as discrete acts in FIG. 3, they can be performed simultaneously. For example, in one embodiment of the invention, the file system location may be specified as command line parameters when the first software application calls the second software application.

After the second application is provided with the information in act 305, the process then continues to act 307, where the user uses the second software application to create or capture multi-media data, such as digital images, movies, sound and/or text. The process then proceeds to act 309, where the second software application stores the multi-media data at the file system location specified by the first software application (in act 305) using the file names specified by the first software application. Once the multi-media data files are stored, the process continues to act 311, where the user exits the second software application and returns to the first software application.

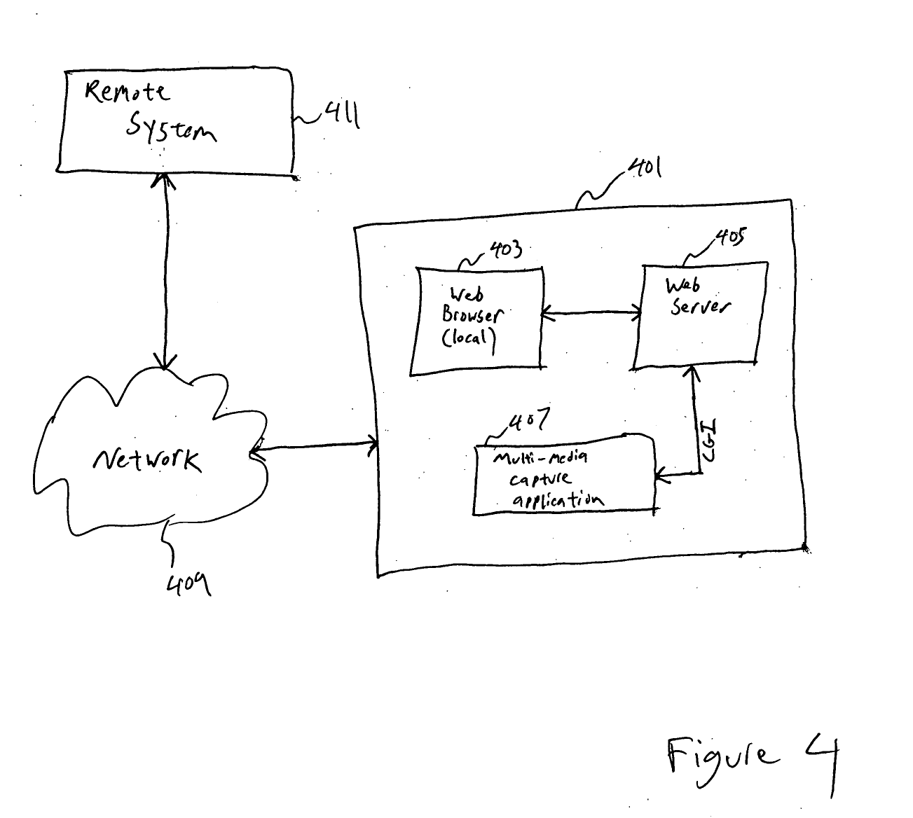

In one embodiment of the invention, the first software application is an Internet web browser working in combination with an Internet web server as described below with reference to FIG. 4, which is a block diagram of a system 401 that may be used to associate multi-media data with hypertext markup language (HTML) documents. System 401 is coupled to a network 409 which may be any suitable network (e.g., a local area network (LAN) or wide area network (WAN) connected to the Internet). System 401 is assigned a network address such that other systems connected to the Internet or network 409 may send data to and receive data from system 401. For example, remote system 411 may request documents from a web server 405 on system 401. Web server 405 may be implemented by a software application executing on system 401 that is capable of providing data over network 409 upon receiving requests for such data. A web client software application, such as a web browser executing on remote system 411, may request data (such as HTML documents) from web server 405 and display such data to a remote user.

Similarly, web browser 403, executing on system 401, may request HTML documents from web server 405, even though web browser 403 and web server 405 are executing on the same system. However, for security reasons, HTML documents downloaded from a web server typically cannot cause a web browser to open other local software applications for execution. If not for this security provision, then a user could download an HTML document from a malicious web server which, for example, causes the user's system to execute a delete command which deletes the entire contents of the system's file system. This security provision may prevent the web browser 403 from opening an application which may be used to capture or create multi-media data for association with an HTML document. Thus, in one embodiment, web server 405 is used to open multi-media capture application 407, as will be described below in greater detail.

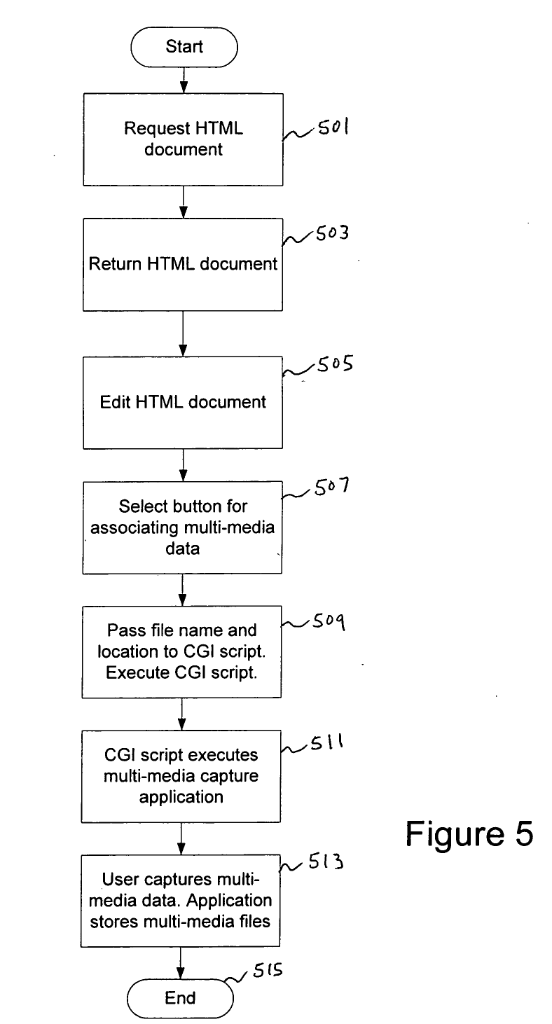

FIG. 5 is a flow chart illustrating a process by which multi-media data may be associated with an HTML document using a web browser and a web server in accordance with one embodiment of the invention. The process begins at act 501, wherein web browser 403 requests an HTML document from web server 405. The process continues to act 503, where web server 405 returns the requested HTML document to web browser 403. The HTML document may include an HTML form that comprises checkboxes, text input boxes, pull down menus, radio buttons, and/or other suitable input mechanisms which allow the user to edit the document. The document may also include buttons or hypertext links, such as the buttons 203 of FIG. 2, which when selected by a user allow the user to associate multi-media data with the document. Further, the HTML form may include a submit button which, when selected by the user, returns the contents of the HTML form to web server 405, using the standard HTML GET or POST methods for data transmission. That is, the web browser sends data to web server 405 indicating which checkboxes have been checked, which menu items have been selected, etc.

It should be appreciated that the HTML form described above is only one example of a form that is suitable for use in embodiments of the present invention. Many variations of such a form are possible, as the invention is not limited in this respect.

After the web browser 403 receives the requested HTML document from web server 405, the process continues to act 505, wherein the user may edit the HTML document by checking various checkboxes, inputting text, and/or selecting various menu items and radio buttons (i.e., using the input mechanisms provided in the HTML form). The process then continues to act 507, wherein the user selects one of the buttons for associating multi-media data with the electronic document. As shown at act 509, selection of the button causes web server 405 to execute a common gateway interface (CGI) script on the system executing web server 405 (i.e., system 401). Selection of the button also passes a file name and file system location to the CGI script.

At act 511, the CGI script causes system 401 to execute multi-media capture application 407, instructing the multi-media capture application to store any multi-media data files with the file name and file system location received from web browser 403. If the user were to access web server 405 through a web browser on a remote system (e.g., remote system 411), then the user would not have access to multi-media capture application 407 because the multi-media capture application executes on the same system as web server 405. That is, the web browser on the remote system would, for example, cause the web server to execute a CGI script that calls the multi-media capture application. The multi-media capture application would then execute on the same system as the web server. Thus, the user of the web browser on the remote system cannot operate the multi-media capture application, as it is executing on a different system. However, because web browser 403 and web server 405 are both executing on system 401, the user can access and operate multi-media capture application 407.

It should be appreciated that the use of CGI script is only one example by which the first application (i.e., the document editing applications) may cause the computer system to execute the second software application (i.e., the multi-media capture application). Other ways of accomplishing this are possible and the invention is not limited in this respect.

The process next continues to act 513 where the multi-media capture application 407 (under control of the user) captures multi-media data stores it on system 401 using the specified location information (e.g., file name and file system location). At act 515, the process ends.

Once the user has finished editing the HTML document and the desired multi-media data has been associated with the document, the user may submit the contents of the HTML document to web server 405 by selecting the submit button on the HTML form (e.g., using the standard HTML GET or POST method of transferring data, or any other suitable way). That is, for example, web browser 403 indicates to web server 405 which checkboxes of the HTML document were checked, which radio buttons were selected, and/or what text was input into the text boxes of the HTML document. Submitting the contents of the HTML document to web server 405 causes web server 405 to create a new HTML document (e.g., by executing a second CGI script) having the data contents that were transferred to web server 405 by web browser 403. Thus, the newly created HTML document looks very similar to the HTML document that the user edited using web browser 403.

In one embodiment, the new document is created so that the original document may be used repeatedly as a template. For example, when using a physical paper checklist to perform maintenance checks on aircraft, it may be desirable to have multiple copies of the checklist so that the maintenance check can be performed multiple times (e.g., at regularly scheduled maintenance intervals). Thus, it may be desired to maintain a clean copy of the checklist as an original so that copies may be made from it for use in performing maintenance checks. Likewise, the original HTML document serves as the master original copy. This original document may be edited to include information and multi-media data input by the user, but it is saved as a new HTML document such that the original HTML document may be re-used in creating other documents.

In one embodiment, the web server (e.g., via the second CGI script) may add some additional information to the newly created HTML document. For example, the web server may determine if the user associated any multi-media data with the document. This determination can be made in any of numerous ways, for example, using the naming convention for determining the names and locations of multi-media files. That is, the web server may determine the file system location that was provided to the multi-media capture application and look at that location to determine if any multi-media data files exist there. If multi-media data files exist there, the web server may determine the location in the HTML file with which the multi-media data files are associated and create a hypertext link or button at that location in the newly created HTML file which allows for the viewing of the multi-media data files. Such a hypertext link or button, when selected by a user viewing the HTML page, may, for example, cause web server 405 to provide web browser 403 with the multi-media data associated with that document location so that the web browser 403 can display the multi-media data to the viewer.

As mentioned above, in one embodiment, the newly created HTML document may include buttons distributed throughout the document whether or not there is multi-media data associated with that location in the HTML document. If a user selects a button at a location with which no multi-media data is associated, then web server 405 may provide a message to web browser 403 indicating that no multi-media data is available. In another embodiment, the web server (e.g., via the CGI script) may create a read-only version of the HTML document that omits the buttons that allow users to associate multi-media data with the document. The read-only version of the document may also omit the submit button used to submit the contents of the HTML form to the web server so that even if a user does edit the HTML form, the edited contents cannot be submitted to the web server and saved.

For any of the embodiment described above, after the web server (e.g., via the CGI script) adds (or omits) the information to the newly created HTML document, it then stores the new HTML file on system 401. Web server 405 may then provide the new HTML file in response to requests from other web clients, such as web browser 403 and remote system 411.

When a user desires to view the new HTML document, the user may simply issue a request (e.g., using a web client, such as web browser 403) for the document to web server 405. Web server 405 then returns the document to the client that issued the request. The use of a web server, such as web server 405, allows remote users to view the documents (including the multi-media data associated therewith) created by the user of system 401. Accordingly, a user of remote system 411 may request an HTML document created by web server 405 (e.g., via the CGI script). Web server 405 may provide the HTML document and associated multi-media data to remote system 411.

Thus, for example, in the aircraft maintenance example described above, a maintenance worker may use a system such as system 401 to edit maintenance checklists and to associate multi-media data (e.g., still or moving images) with the maintenance checklists. Once the maintenance worker has completed the maintenance check, the checklist and associated data are then available for viewing by a supervisor using a remote system, such as remote system 411. Decisions as to whether to repair or replace parts or ground an aircraft may be made remotely by the supervisor.

The use of a web server in associating multi-media data with a document may be useful in other situations as well, such as the above-described real estate broker example where a broker desires to post real estate listings on the Internet, or the automobile salesperson who desires to post advertisements for automobiles on the Internet. It should be appreciated that these are only a few examples of situations in which the use of a web server aids in associating multi-media data with electronic documents, as the aspects of the present invention described herein can be used with numerous other applications.

It should further be appreciated that a web browser, such as web browser 403, is only one example of a software application that may be used to view or edit electronic documents. Many other software applications may be used (e.g., word processors, text editors, image editors), as the invention is not limited in this respect. Further, it should be understood that some of these software applications may not be limited by the security restrictions of a typical web browser and therefore can access the local file system and open other local programs for execution. In these situations, the software application may directly open a multi-media capture application, providing it with the appropriate location information (e.g., file name and file system). The software application may also format the electronic documents and save them to disk. Thus, web server program 405 need not act as an intermediary between the document editing application and the multi-media capture application.

Although in such situations the web server does not participate in the editing of an electronic document or the associating of data with an electronic document, the web server may still be used to provide the documents created by the user over a network (e.g., the Internet) to remote users. Thus, for example, the software application may, by itself, provide the ability to edit and associate multi-media data with an electronic document. The software application may then save the electronic document at a location that allows a web server to make the document available to remote users over the network.

In the above described example, the electronic documents manipulated by the user and system 401 were formatted as HTML documents. It should be appreciated that HTML is only one example of a document format can be used in various embodiments of the present invention. Other document formats, such as plain text, portable document format (PDF), rich text format, postscript format, or any suitable document format (including customized formats) may be used, as the invention is not limited in this respect.

Providing Real Time Images Over a Network

As discussed above, one embodiment of the invention enables providing real time images over a network. This advantageous, as it can convey information to a remote individual that is difficult or impossible to convey in words (e.g., over a telephone). Returning to the aircraft maintenance example, a maintenance worker who is inspecting an aircraft may wish to receive a second opinion on whether it is necessary to repair or replace a particular part. Embodiments of the present invention allow the maintenance worker to provide real time images to someone who has the authority to make such a decision, even though that person may be physically remote from the aircraft (i.e., in another city, state, or country) and unable to view the area of interest.

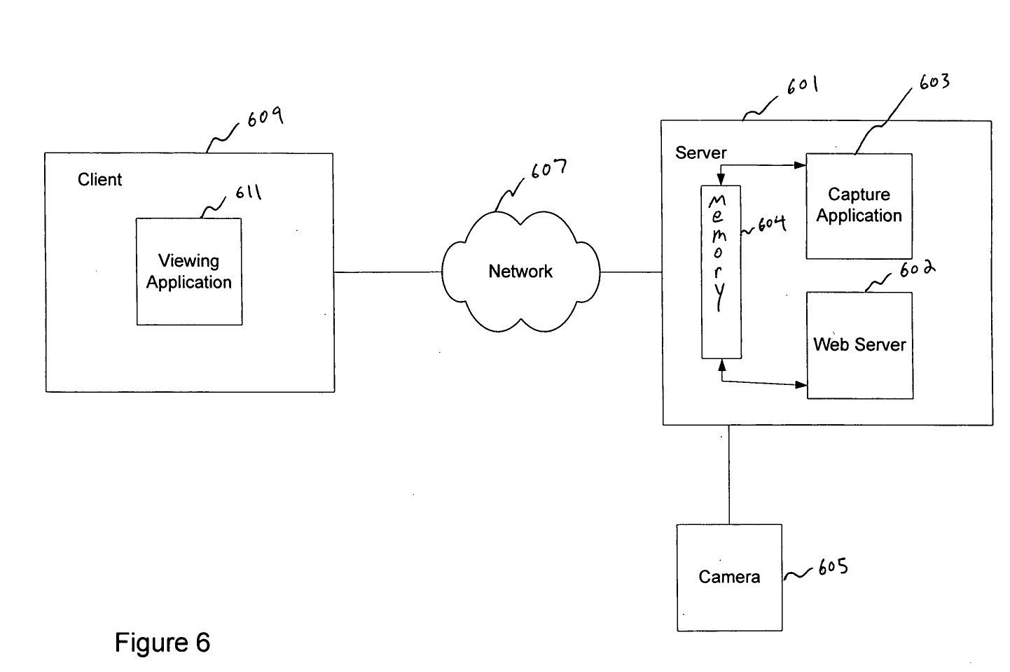

FIG. 6 is a block diagram illustrating another aspect of the invention, in which a user may view real-time images over a network. FIG. 6 shows a server 601 which includes a capture application 603, a web server 602, and a storage device 604. A camera 605 is coupled to server 601. Server 601 is also accessible to clients, such as client 609, over network 607. Client 609 includes a viewing application 611 which downloads data over network 607 and displays it to a user for viewing or editing.

Capture application 603 interfaces with camera 605 and may control the operation of camera 605. For example, capture application 603 may instruct camera 605 to take a certain number of photographs and return the photographs as digital images. Capture application 603 may then save these images to the storage device 604, which may include volatile memory (e.g. RAM), non-volatile storage media (e.g., magnetic or optical media), or any combinations thereof.

Web server 602 may make data, such as HTML documents, available over network 607. Any such HTML documents may include a refresh period that indicates to the viewing application, such as a web browser, that the document should refreshed after a certain period of time. That is, for example, the HTML document may specify a relatively short refresh period of five seconds, the expiration of which causes the viewing application (e.g., a web browser) to reload the HTML document. Thus, if the viewing application abides by the refresh period specified in the HTML document, then after five seconds have expired, the viewing application will again request the HTML document from the web server and receive a new copy of the HTML document. If the refresh period is short, then the document will be refreshed constantly, such that a series of images displayed in the document may appear as a live moving image, as is discussed below in greater detail.

In addition to specifying a refresh period, the HTML document may include content, such as text and images. For example, the HTML document may include an image named, for example, “file1.jpg.” In one embodiment, the HTML document indicates the location in which the multi-media data (e.g., image file1.jpg) is to appear in the document using a placeholder referred to as an image tag. The image tag specifies the file name of the image to be displayed at that location in the document. Thus, when the viewing application requests and receives the HTML document, the viewing application may note that a file named file1.jpg is intended to appear at a particular location in the document. Accordingly, the viewing application may request and receive from the web server the file name file1.jpg to be displayed at the appropriate place in the HTML document.

In one embodiment of the invention, web server 602 provides access over network 607 to several HTML documents which are stored in storage device 604. The HTML documents may be identical, except that each one specifies a different refresh rate. For example, web server 602 may provide access to an HTML document named sample3.html which specifies a refresh period of 0.33 seconds (3 times per second), a document named sample4.html which specifies a refresh period of 0.25 seconds (4 times per second), and sample5.html which specifies a refresh period of 0.20 seconds (5 times per second). Each of these HTML files may include a placeholder for an image named file1.jpg and hypertext links to the other two HTML files that may be used to change the refresh rate. That is, sample3.html may include a hypertext link to sample4.html, which when selected by a user viewing sample4.html with a viewing application (e.g., viewing application 611) sends a request to the web server for sample4.html. Sample3.html also includes a hypertext link to sample5.html. Likewise, sample4.html may include hypertext links to sample 3.html and sample5.html, whereas sample5.html may include hypertext links to sample3.html and sample4.html.

It should be appreciated that the use of hyperlinks in HTML documents is one example of a way in which the refresh rate may be altered. Other suitable ways of altering the refresh period may be used, as the invention is not limited in this respect.

As discussed above, capture application 603 may be used to instruct camera 605 to continuously take pictures and return digital images to camera application 603. When capture application 603 receives a digital image from camera 605, it stores the digital image in storage device 604 using the file name file1.jpg. Each time capture application 603 receives a new digital image from camera 605, it overwrites the previous file1.jpg and stores a new file1.jpg that includes the new digital image.

On the client side, viewing application 611, which may be, for example, a web browser or other suitable application, requests an HTML document from web server 602 over network 607. For example, viewing application may request and receive the document sample5.html from web server 602. Because sample5.html includes a placeholder for the image file named file1.jpg, viewing application will also request file1.jpg from web server 602. Further, because sample5.html specifies a refresh rate of 0.20 seconds, viewing application 611 will request and receive the document file1.jpg five times each second. Because capture application 603 is continuously rewriting file1.jpg with new digital images, each time viewing application requests file1.jpg, it may receive a different digital image (albeit with the same file name). Thus, as the viewing application downloads a new copy of sample5.html and file1.jpg every 0.20 seconds, the user of viewing application 611 will see a real-time movie comprised of the images taken by camera 605, at a rate of five frames per second.

In some situations, the bandwidth of the network connection between client 609 and server 601 may not be sufficient to support a five frame per second refresh rate. That is, due to high network traffic or the limitations of the physical devices (e.g., routers, switches) or physical connections (e.g., network cables), it may not be possible to transfer five copies of file1.jpg in one second. The user can decrease the rate at which the HTML document and the image file are downloaded by selecting one of the hypertext links to one of the other HTML documents. For example, the user may select the hypertext link to the HTML document sample4.html. This selection causes viewing application 611 to request the document sample4.html from web server 602. Because sample4.html also includes a placeholder for file1.jpg, viewing application 611 will also request file1.jpg from web server 602. However, the refresh period for sample4.html is longer than that of sample5.html. Viewing application 611 will now only download a new copy of sample4.html and file1.jpg every 0.25 seconds or four times per second. In this manner, the user can select different refresh rates depending upon the bandwidth of network connection between client 609 and server 601.

In the above example, three HTML files were provided, having refresh rates of three, four, and five times per second. It should be appreciated that these HTML files are provided only as examples, and that any number of HTML files having any number of different refresh rates may be provided, as the invention is not limited in this respect. Further, the above example was described in a world wide web (WWW) context, using a web server to provide web pages and web browser as the viewing application. It should be appreciated that the WWW context is only one context in which embodiments of the invention may be used. Indeed, the server application 602 need not be a web server and the viewing application 611 need not be a web browser. Any software applications between which files may be transferred over a network may be used.

Determining the Size of Objects in Digital Images

Another embodiment of the invention is directed to determining the size of an object in an image being viewed. For example, when viewing an image of an aircraft part, it may be desirable to determine the size of a crack in that aircraft part in making a decision as to whether to replace the part. It may be difficult or impossible to physically measure the crack, as the crack may be too small to physically measure or may be in a position that is difficult to reach without removing the part from the aircraft.

One embodiment of the invention is directed to a technique and system for accurately measuring the size of an object in an image. This can be done in numerous ways. In one embodiment, a displacement measurement system is used that includes a sensor that allows one to determine the distance from the sensor tip to a target object. One example of such a sensor uses bundled glass fibers to transmit light to, and to receive reflected light from, the target surface at a distance up to 50 mm. The intensity of the reflected light is proportional to the distance between the sensor tip and the target surface, and is measured to determine the distance. An example of such a displacement measurement system is commercially available from Philtec, Inc., having a place of business at 1021 St. Margarets Ave. Annapolis, Md. 21410. However, the invention is not limited to using a sensor from Philtec, Inc., to one that uses reflected light, or to one that measures distances up to 50 mm, as other types of sensors can be used.

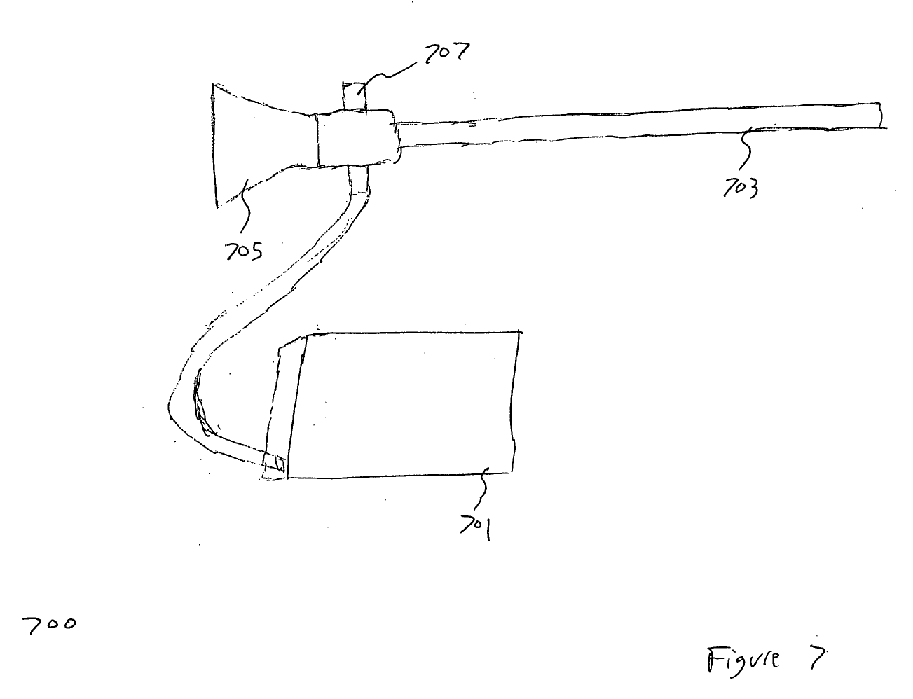

In one embodiment, a measuring system 700 shown in FIG. 7 may be used to determine the size of an object from an image of the object. The measuring system comprises a displacement measurement system 701, a scope 703, and a camera 705. The scope 703 (e.g., a borescope, endoscope, or other scope) coupled to the camera 705 may be used to take images of objects that are difficult to reach. An example of such a scope coupled to a camera is the Universal Cam with Coupler and Scope available from Vision Technologies, having a place of business at 119 East Walnut, Rogers, Ark., 72756, but other scopes can also be employed. The scope may include a light source 707 to aid in the taking of an image. In accordance with one embodiment of the invention, a displacement measurement system 701 is integrated with the scope. In the example of FIG. 7, the optical fibers of the displacement measurement system are integrated into the housing of the scope.

Although camera 705 is shown as coupled to the distal end of scope 703 in the embodiment of FIG. 7, it should be appreciated that the invention is not limited in this respect, as camera 705 may be coupled to scope 703 in any suitable way and at any suitable location. For example, camera 705 may be coupled to scope 703 at the proximal end, or anywhere along the length of the scope.

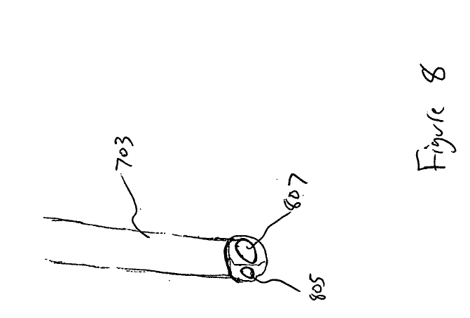

FIG. 8 is a cross-sectional view of the tip of scope 703. In FIG. 8, optical fibers 805 of displacement measurement system 701 are integrated into the housing of scope 703. Also in the housing is lens 807 of the scope 703, through which images of the target object may be viewed. It should be understood that the manner in which displacement measurement system and scope 703 are coupled in FIGS. 7 and 8 is only an example, and that displacement measurement system 701 and scope 703 can be coupled in any suitable way, as the invention is not limited in this respect. For example, the optical fibers may be attached externally to the housing of the scope.

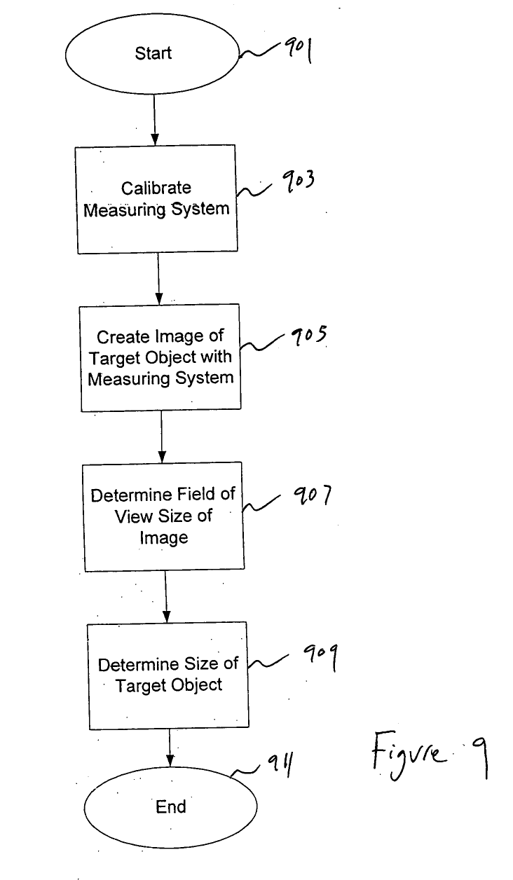

When taking an image of an object using the scope, the displacement measurement system can determine the distance from the object at which the image was taken, and this distance may be used to determine the size of the field of view of the image in accordance with one embodiment of the invention. An example of a process for determining the size of the object from an image of the object is shown in FIG. 9.

At act 901, the process begins. The process then proceeds to act 903, where the measuring system is calibrated. In one embodiment, the measuring system is calibrated by taking one or more (e.g., five or six) images of a target object with the scope and displacement measurement system from various distances, with the field of view being of known size. Creating an image with a field of view of known size may be accomplished, for example, by physically measuring the area that is shown in the image. It should be understood, however, that there are many other ways for creating an image with a known field of view size, and the invention is not limited to any particular technique.

The size of the field of view of these images can be plotted against the distance from the target object as measured by the measurement system to create a calibration curve for a particular scope and displacement measurement system combination. It should be appreciated that the invention is not limited to the above-described technique for calibrating a scope, as any suitable calibration technique can be employed.

Once the calibration is complete, the process continues to act 905, where an image of the target object is created using the measuring system. It should be appreciated that the measuring system need not be calibrated each time a target object is measured. For example, the measuring system may be initially calibrated, and those calibrations may be used for multiple different measurements. In this respect, if the measuring system is already calibrated, the process of FIG. 9 may skip act 903 and proceed directly to act 905.

When an image of an object is taken, the process continues to act 907, where the size of the field of view of the image is determined. Displacement measurement system can determine the distance from the target object at which the image was taken and the point on the calibration curve that matches the distance from which the image was taken can be found to determine the size of the field of view.

Once the size of the field of view of the image is known, the process continues to act 909, where the size of the target object is determined from the image. A mapping can be performed between the pixels in the image and the actual physical distance (e.g., the number pixels per millimeter) that they represent. This information may then be used to determine the size of cracks or other objects which appear in the image.

Applicants have appreciated that a problem associated with using a displacement measurement system attached to a scope is that the light source of the scope can interfere with the measurements taken by the displacement measurement system when the displacement measurement system relies on evaluating the intensity of reflected light. Applicants have further appreciated that some displacement measurement system measure the intensity of light only in a limited range outside of the visible spectrum (e.g., in the infrared frequency range) and ignore light at other frequencies. Thus, in one embodiment of the invention, a filter is placed on the light source of the scope to filter light in the range used by the displacement measurement system (e.g., light in the infrared frequency range). That is, the filter only allows light outside the range used by the measurement system to pass through, and blocks light in the range used by the measurement system. As a result, the light that passes through the filter does not interfere with the measurements taken by the displacement measurement system.

It should be appreciated that although an example is given above in which embodiments of the invention are used to determine the size of objects in images of aircraft parts, the invention is not limited in this respect, as the invention may be used to determine the size of any objects in any image.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above. The one or more controllers may be included in one or more host computers, one or more storage systems, or any other type of computer that may include one or more storage devices coupled to the one or more controllers.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer system resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” or “having,” “containing”, “involving”, and variations thereof herein, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. A method of determining a size of an object, the method comprising acts of:
a) capturing a digital image of a field of view that includes the object;
b) determining the size of the field of view captured in the digital image; and
c) determining the size of the object based on the size of the field of view captured in the digital image.

2. The method of claim 1, wherein the act a) further comprises an act of:
capturing the digital image using a system that includes a scope to receive the image, a camera coupled to the scope to capture the image received by the scope, and a measurement displacement system coupled to the scope to determine a distance of the scope from the object.

3. The method of claim 2, wherein the act b) further comprises acts of:
using the measurement displacement system to determine a distance of the scope from the object when the image was captured; and
determining a size of the field of view of the digital image based on a calibration curve that maps distance between the scope and the object to field of view size.

4. The method of claim 3, wherein the act c) further comprises acts of:
determining a number of pixels in the digital image that depict the field of view; and
determining a number of the pixels in the image that depict object.

5. The method of claim 4, further comprising an act of:
comparing the number of pixels in the image of the object to the number of pixels in the digital image to determine the size of the object.

6. The method of claim 3, wherein the scope includes a first light source with light in a first spectrum that illuminates the field of view, wherein the measurement displacement system includes a second light source with light in a second spectrum, wherein the measurement displacement system determines the distance by measuring light from the second source that is reflected off the object and received at a sensor, and wherein the method further comprises an act of:
filtering the light from the first light source of the scope so that light from the first light source does not reach the sensor and interfere with the measurement by the measurement displacement system.

7. At least one computer readable medium encoded with instructions that, when executed on a computer system, perform a method of determining a size of an object, the method comprising acts of:
a) capturing a digital image of a field of view that includes the object;
b) determining the size of the field of view captured in the digital image; and
c) determining the size of the object based on the size of the field of view captured in the digital image.

8. The at least one computer readable medium of claim 7, wherein the act a) further comprises an act of:
capturing the digital image using a system that includes a scope to receive the image, a camera coupled to the scope to capture the image received by the scope, and a measurement displacement system coupled to the scope to determine a distance of the scope from the object.

9. The at least one computer readable medium of claim 8, wherein the act b) further comprises acts of:
using the measurement displacement system to determine a distance of the scope from the object when the image was captured; and
determining a size of the field of view of the digital image based on a calibration curve that maps distance between the scope and the object to field of view size.

10. The at least one computer readable medium of claim 9, wherein the act c) further comprises acts of:
determining a number of pixels in the digital image that depict the field of view; and
determining a number of the pixels in the image that depict object.

11. The at least one computer readable medium of claim 10, wherein the method further comprises an act of:
comparing the number of pixels in the image of the object to the number of pixels in the digital image to determine the size of the object.

12. The at least one computer readable medium of claim 9, wherein the scope includes a first light source with light in a first spectrum that illuminates the field of view, wherein the measurement displacement system includes a second light source with light in a second spectrum, wherein the measurement displacement system determines the distance by measuring light from the second source that is reflected off the object and received at a sensor, and wherein the method further comprises an act of:
filtering the light from the first light source of the scope so that light from the first light source does not reach the sensor and interfere with the measurement by the measurement displacement system.

13. A computer system comprising:
a display;
at least one controller coupled to the display that:
captures a digital image of a field of view that includes the an object;
determines the size of the field of view captured in the digital image; and
determines the size of the object based on the size of the field of view capture in the digital image.

14. The computer system of claim 13, wherein the at least one controller captures the digital image using a system that includes a scope to receive the image, a camera coupled to the scope to capture the image received by the scope, and a measurement displacement system coupled to the scope to determine a distance of the scope from the object.

15. The computer system of claim 14, wherein the at least one controller:
uses the measurement displacement system to determine a distance of the scope from the object when the image was captured; and
determines a size of the field of view of the digital image based on a calibration curve that maps distance between the scope and the object to field of view size.

16. The computer system of claim 15, wherein the at least one controller:
determines a number of pixels in the digital image that depict the field of view; and
determines a number of the pixels in the image that depict object.

17. The computer system of claim 16, wherein the at least one controller:
compares the number of pixels in the image of the object to the number of pixels in the digital image to determine the size of the object.

18. The computer system of claim 15, wherein the scope includes a first light source with light in a first spectrum that illuminates the field of view, wherein the measurement displacement system includes a second light source with light in a second spectrum, wherein the measurement displacement system determines the distance by measuring light from the second source that is reflected off the object and received at a sensor, and wherein the system further includes a filter that filters the light from the first light source of the scope so that light from the first light source does not reach the sensor and interfere with the measurement by the measurement displacement system.

19. The method of claim 1, wherein the object is at least a portion of an aircraft component, wherein the act a) further comprises an act of capturing a digital image of a field of view that includes the at least a portion of the aircraft component, and wherein the act c) further comprises determining the size of the at least a portion of the aircraft component based on the size of the field of view captured in the digital image.

20. The at least one computer readable of claim 7, wherein the object is at least a portion of an aircraft component, wherein the act a) further comprises an act of capturing a digital image of a field of view that includes the at least a portion of the aircraft component, and wherein the act c) further comprises determining the size of the at least a portion of the aircraft component based on the size of the field of view captured in the digital image.

21. The computer system of claim 13, wherein the object is at least a portion of an aircraft component, and wherein the at least one controller captures a digital image of a field of view that includes the at least a portion of the aircraft component and determines the size of the at least a portion of the aircraft component based on the size of the field of view captured in the digital image.
